(19) United States
(12) Patent Application Publication
(10) Pub. No.: US 2023/0377794 A1
(43) Pub. Date: Nov. 23, 2023

(54) ELECTRONIC COMPONENT AND METHOD OF MANUFACTURING THE SAME

(71) Applicant: TDK CORPORATION, Tokyo (JP)

(72) Inventors: Kazushige TOHTA, Tokyo (JP); Shintarou KOIKE, Tokyo (JP); Masashi GOTOH, Tokyo (JP); Takuto KAZAMA, Tokyo (JP)

(73) Assignee: TDK CORPORATION, Tokyo (JP)

(21) Appl. No.: 18/320,453

(22) Filed: May 19, 2023

(30) Foreign Application Priority Data
May 20, 2022 (JP) 2022-083158
May 17, 2023 (JP) 2023-081760

(51) Int. Cl. H01F 27/29; H01F 27/28; H01F 27/02

(52) U.S. Cl. CPC H01F 27/292; H01F 27/2828; H01F 27/02

(57) ABSTRACT

An electronic component includes an element body and an electrode terminal. The electrode terminal includes a terminal body extending in a planar shape along a main surface of the element body, and at least one of an outward protrusion continuously and integrally formed with the terminal body and protruding outside the main surface and an inward protrusion continuously and integrally formed with the terminal body and extending inside of the element body from the main surface.

### CROSS REFERENCE TO RELATED APPLICATION

This application claims priority based on Japanese Patent Application No. 2022-083158 filed on May 20, 2022 and Japanese Patent Application No. 2023-081760 filed on May 17, 2023, and the whole of the disclosure of the above application is incorporated herein by reference.

### BACKGROUND

The present disclosure relates to an electronic component in which an electric element, such as a coil, is embedded in an element body and a method of manufacturing the same.

In an inductor described in, for example, Patent Document 1, a boundary between a lead-out portion and a wide terminal portion of a coil wire is disposed inside a magnetic body to prevent cracks that may cause connection failures.

Along with a smaller size and higher performance of electronic equipment, electronic components included in such electronic equipment are increasingly having a smaller size and higher performance. As the electronic components reduce in size, it normally tends to be difficult to form terminals and mount the electronic components on a substrate or the like. Nevertheless, with regard to performance and reliability of the electronic components and mounting reliability of the electronic components on the substrate or the like, still higher performance and reliability are in demand.
Patent Document 1: JP Patent Application Laid Open No. 2009-123927

### SUMMARY

An electronic component according to an aspect of the present disclosure includes:
an element body and an electrode terminal,
wherein the electrode terminal includes a terminal body extending in a planar shape along a main surface of the element body, and an outward protrusion continuously and integrally formed with the terminal body and protruding outside the main surface.

An electronic component according to another aspect of the present disclosure includes:
an element body and an electrode terminal,
wherein the electrode terminal includes a terminal body extending in a planar shape along a main surface of the element body, and an inward protrusion continuously and integrally formed with the terminal body and extending from the main surface into an inside of the element body.

A method of manufacturing an electronic component according to an aspect of the present disclosure, includes:
processing an end of a wire of an electric element into a sheet shape so that the end has a thickness smaller than that of the wire apart from the end and a width larger than that of the wire apart from the end;
forming an electrode terminal at the end processed into the sheet shape, the electrode terminal including a terminal body and an outward protrusion; and
forming an element body so that an outer surface of the electrode terminal is exposed and the electric element is covered by the element body.

A method of manufacturing an electronic component, according to another aspect of the present disclosure, includes:
processing an end of a wire of an electric element into a sheet shape so that the end has a thickness smaller than that of the wire apart from the end and a width larger than that of the wire apart from the end;
forming an electrode terminal at the end processed into the sheet shape, the electrode terminal including a terminal body and an inward protrusion; and
forming an element body so that an outer surface of the electrode terminal is exposed and the electric element is covered by the element body.

### BRIEF DESCRIPTION OF THE DRAWINGS

FIG. 1A is a transparent perspective view of a coil component according to a first aspect of the subject technology.

FIG. 1B is an external perspective view of the coil component shown in FIG. 1A viewed from a mounting surface side of the coil component.

FIG. 2A is a transparent front elevational view of the coil component shown in FIG. 1A.

FIG. 2B is a transparent bottom plan view of the coil component shown in FIG. 1A.

FIG. 2C is a transparent side elevational view of the coil component shown in FIG. 1A.

FIG. 2D is a front elevational view of an electrode terminal of the coil component shown in FIG. 1A and an enlarged diagram of a region IID shown in FIG. 2A.

FIG. 2E is a diagram of a modified example of an outward protrusion of the coil component shown in FIG. 1A.

FIG. 2F is a perspective view of the electrode terminal of the coil component shown in FIG. 1A.

FIG. 2G is a perspective view of a modified example of the electrode terminal shown in FIG. 2F.

FIG. 2H is a perspective view of the electrode terminal shown in FIG. 2F viewed from another angle.

FIG. 2I is a perspective view of another modified example of the electrode terminal shown in FIG. 2H.

FIG. 3A is a flowchart of a method of manufacturing the coil component shown in FIG. 1A.

FIG. 3B is a diagram illustrative of an example of a wire winding step of FIG. 3A.

FIG. 3C is a diagram illustrative of an example of a wire squeezing step of FIG. 3A.

FIG. 3D is a diagram illustrative of an example of forming outward bent portions in a terminal forming step of FIG. 3A.

FIG. 3E is a diagram illustrative of an example of bending terminal bodies and cutting excessive portions in the terminal forming step of FIG. 3A.

FIG. 3F is a diagram illustrative of an example of a plating treatment step of FIG. 3A.

FIG. 4A is a perspective view of a coil portion and electrode terminals of a coil component according to a second aspect of the subject technology.

FIG. 4B is a transparent perspective view of a coil component according to a third aspect of the subject technology.

FIG. 4C is a transparent front elevational view of the coil component shown in FIG. 4B.

FIG. 4D is a perspective view of a coil portion and electrode terminals of a coil component according to a fourth aspect of the subject technology.

FIG. 4E is a perspective view of a coil portion and electrode terminals of a coil component according to a fifth aspect of the subject technology.

FIG. 5A is a transparent perspective view of a coil component according to a sixth aspect of the subject technology.

FIG. 5B is an external perspective view of the coil component shown in FIG. 5A viewed from a mounting surface side of the coil component.

FIG. 5C is a transparent front elevational view of the coil component shown in FIG. 5A.

FIG. 5D is a front elevational view of an electrode terminal of the coil component shown in FIG. 5A and an enlarged diagram of a region VD shown in FIG. 5C.

FIG. 5E is a diagram illustrative of an example of forming inward bent portions in manufacture of the coil component shown in FIG. 5A.

FIG. 6A is a perspective view of a coil portion and electrode terminals of a coil component according to a seventh aspect of the subject technology.

FIG. 6B is a fragmentary enlarged diagram of an example of an electrode terminal of a coil component according to an eighth aspect of the subject technology.

FIG. 6C is a fragmentary enlarged diagram of another example of an electrode terminal of the coil component according to the eighth aspect of the subject technology.

FIG. 7A is a first schematic view illustrative of an electrode terminal of a coil component according to a ninth aspect of the subject technology.

FIG. 7B is a second schematic view illustrative of the electrode terminal of the coil component according to the ninth aspect of the subject technology.

### DETAILED DESCRIPTION

Hereinafter, embodiments of the present disclosure will be explained with reference to the drawings. The following embodiments of the present disclosure are illustrative exemplifications of the present disclosure. Various components, such as numerical values, shapes, materials, and manufacturing steps, according to the embodiments of the present disclosure may be modified or changed to the extent that technical problems do not arise.

Shapes and the like illustrated in the drawings of the present disclosure do not necessarily match actual shapes and the like, because the former may be modified for illustration purposes.

### First Embodiment

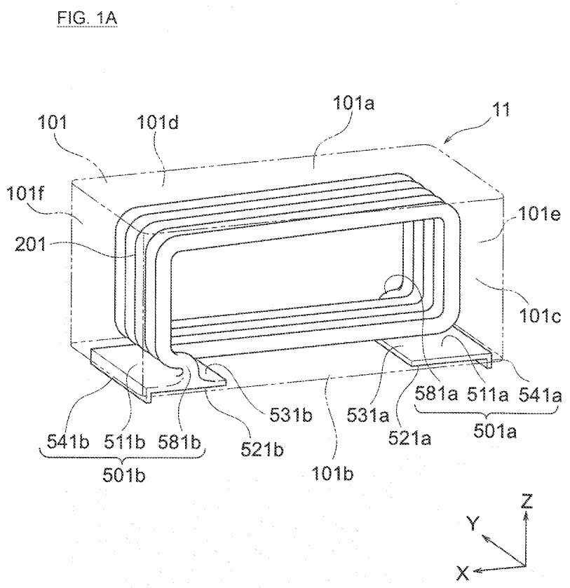

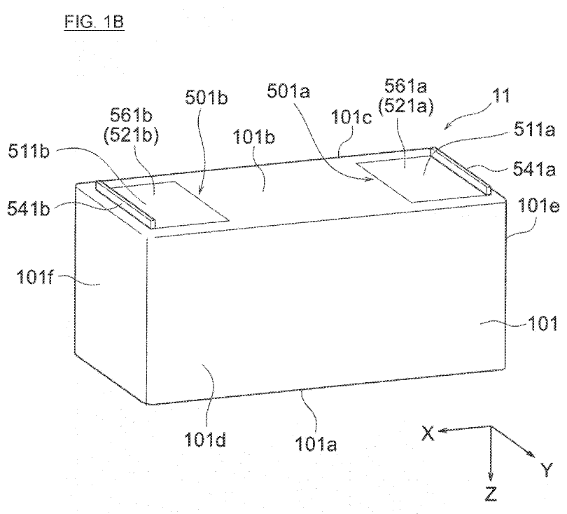

A coil component 11 of a first embodiment will be explained with reference to FIGS. 1A to 3F.

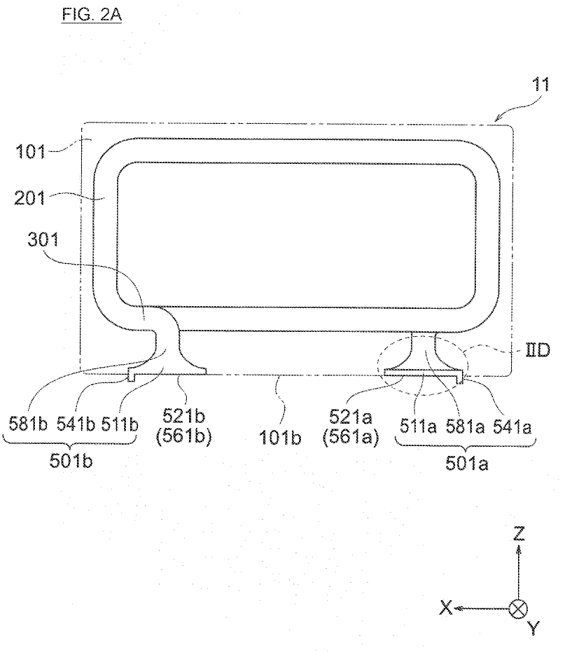

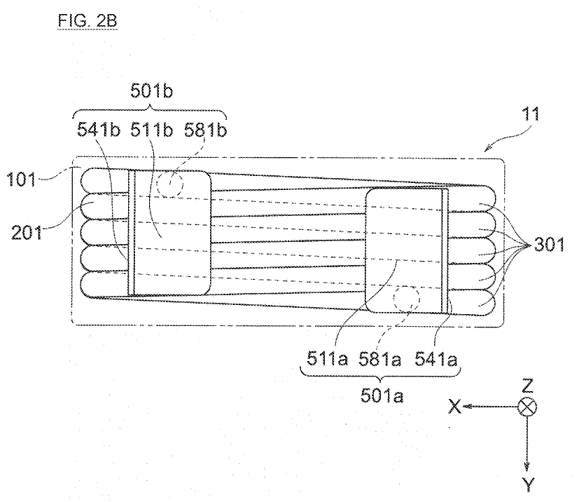

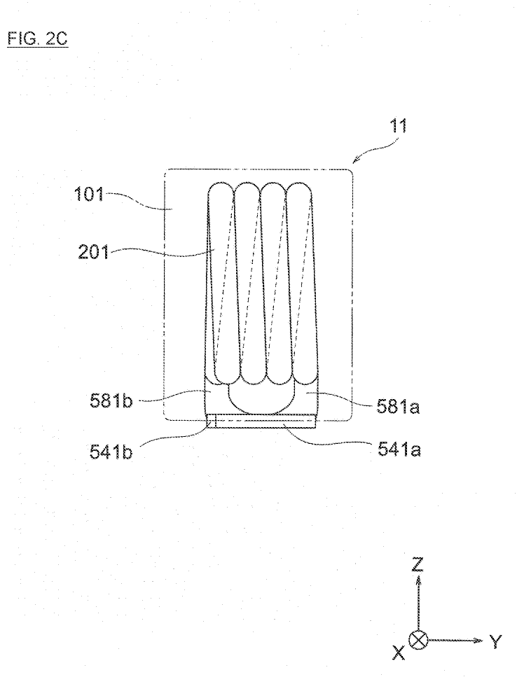

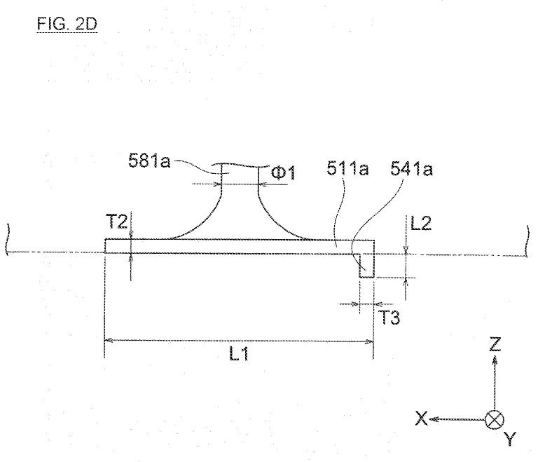

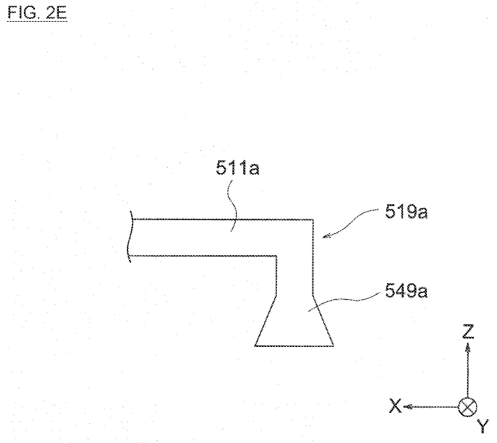

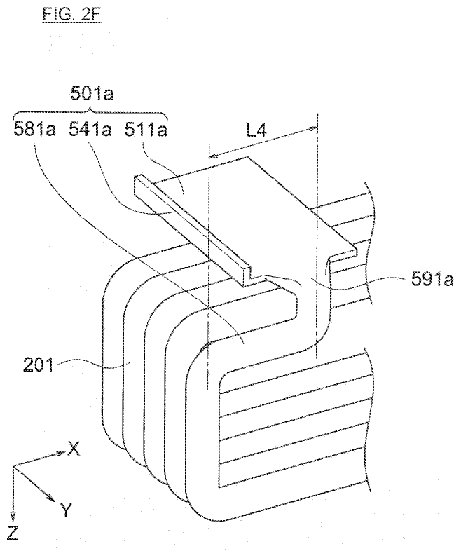

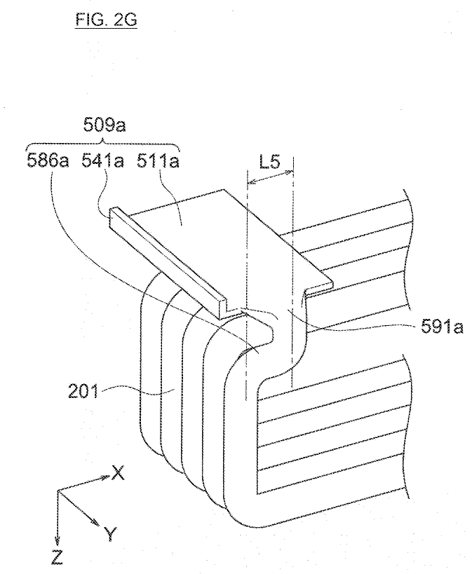

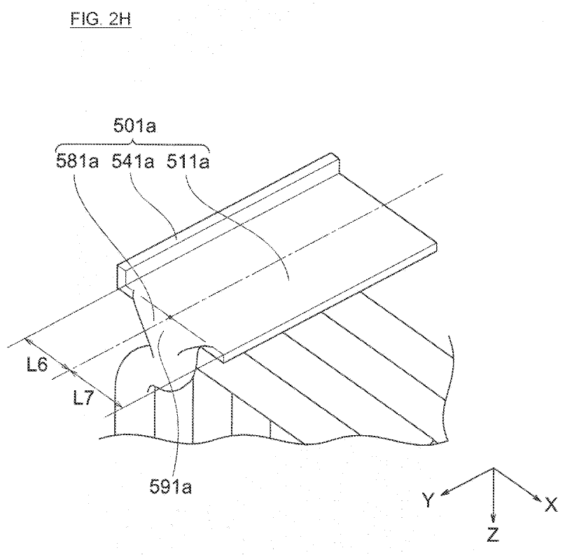

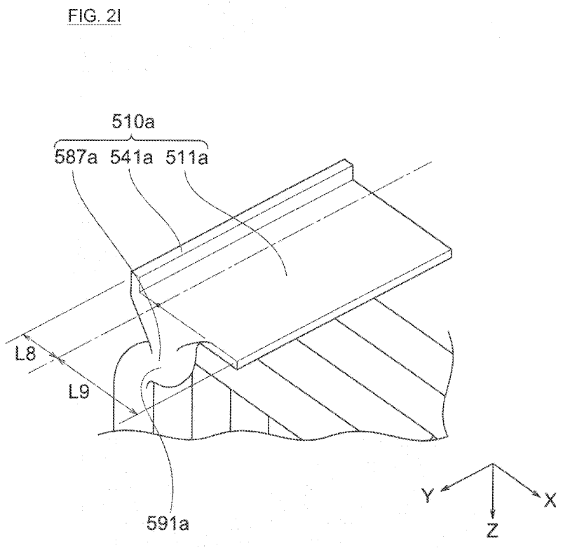

As shown in FIGS. 1A to 2C, the coil component 11 is an electronic component in which an element body 101 is sealed to accommodate an air core coil (a coil portion) 201 as an electric element inside, i.e., an electronic component in which the air core coil is embedded in the element body 101. The coil component 11 includes the element body 101, the coil portion 201, and a pair of electrode terminals 501a and 501b.

The coil component 11 of the present embodiment is a small electronic component having a length of, for example, 5 mm or less, 3 mm or less, or 0.5 mm or less as a length of a longest side in a plane direction and a height of, for example, 5 mm or less, 3 mm or less, or 0.5 mm or less.

The element body 101 is an exterior member that is sealed to accommodate the coil portion 201 inside. As shown in FIGS. 1A and 1B, the element body 101 has a rectangular parallelepiped shape (hexahedral shape) and includes an upper surface 101a, a bottom surface 101b opposite the upper surface 101a in a Z-axis direction, X-axis direction side surfaces 101e and 101f, which are opposite each other along an X-axis, and Y-axis direction side surfaces 101c and 101d, which are opposite each other along a Y-axis. In the present disclosure, rectangular parallelepipeds include a rectangular parallelepiped having chamfered corners and chamfered ridges and a rectangular parallelepiped having rounded corners and rounded ridges.

In the present embodiment, the element body 101 contains a resin material that does not include a magnetic powder. Such a structure reduces permittivity of the element body 101 to allow the coil component 11 to be suitably used at high frequencies. Material of the element body 101 includes, for example, at least one of a thermosetting resin or a thermoplastic resin. The material of the element body 101 includes, for example, at least one selected from the group consisting of an epoxy resin, a polyimide resin, a phenol resin, and an unsaturated polyester resin, as a thermosetting resin. The polyimide resin is, for example, a bismaleimide resin. The material of the element body 101 includes, for example, at least one selected from the group consisting of crystalline polystyrene, a fluorine resin, polyethylene, a liquid crystal polymer, and polyphenylene sulfide (PPS), as a thermoplastic resin. The fluorine resin is, for example, a polytetrafluoroethylene (PTFE) resin. The element body may be composed of a filler-containing resin in which the above-mentioned resins include filler, such as hollow glass and acicular glass. As described later as a modified example, the element body 101 may be composed of a magnetic powder-containing resin that includes a magnetic powder.

The bottom surface 101b of the element body 101 is formed as a main surface that faces a component installation surface (mounting surface) of a substrate or the like where the coil component 11 is to be mounted. At the bottom surface (main surface) 101b, first main surfaces (electrode terminal outer surfaces) 521a and 521b, which are outer surfaces of terminal bodies 511a and 511b of the respective electrode terminals 501a and 501b, are exposed. The electrode terminal outer surfaces 521a and 521b are disposed at the bottom surface 101b apart from each other in the X-axis direction, and the terminal bodies 511a and 511b are insulated from each other.

As shown in FIG. 1B, the terminal bodies 511a and 511b are provided with respective outward protrusions 541a and 541b protruding from the electrode terminal outer surfaces 521a and 521b towards an outer side of the element body 101. The outward protrusions 541a and 541b are formed along respective edges of the electrode terminal outer surfaces 521a and 521b at both sides in the X-axis direction (outermost edges in the X-axis direction that extend in the Y-axis direction), entirely across the electrode terminal outer surfaces 521a and 521b in the Y-axis direction.

When the coil component 11 is mounted on a substrate, the bottom surface (main surface) 101b becomes a mounting surface (mounting surface of the coil component), and the coil component is mounted on the substrate (e.g., a circuit substrate) using a joining member (e.g., solder and conductive adhesive). With the joining member (e.g., solder and conductive adhesive), the electrode terminal outer surfaces 521a and 521b having the outward protrusions 541a and 541b of the coil component 11 are joined to lands or the like constituting part of an electric circuit formed on the substrate or the like.

In the present embodiment, the coil component 11 is explained on the basis that a direction perpendicular to the main surface 101b of the coil component 11 is the Z-axis direction; a direction along the direction in which the pair of electrode terminals 501a and 501b is disposed (a direction along one of the two pairs of facing edges forming a periphery of the main surface 101b) is the X-axis direction; and a direction orthogonal to the X-axis direction and the Z-axis direction is the Y-axis direction.

The coil portion 201 is composed of a wire 301 wound in a coil shape as a conductor. In the present embodiment, the coil portion 201 is accommodated in the element body 101 so that the winding axis of the coil portion 201 is parallel to the mounting surface (vertical placement). Although the coil portion 201 of the coil component 11 of the present embodiment is an air core coil in which the wire 301 is wound in a typical normal-wise manner, the wire may be wound in any manner. For example, the coil portion 201 may be an air core coil in which the wire 301 is α-wound, flat wound, or edgewise wound.

The wire 301 is composed of a conductor portion mainly containing low resistance metal (e.g., copper) and an insulating layer covering an outer periphery of the conductor portion. More specifically, the conductor portion is composed of pure copper (e.g., oxygen-free copper and tough pitch copper), an alloy that contains copper (e.g., phosphor bronze, brass, red brass, beryllium copper, and a silver-copper alloy), a copper-coated steel wire, or the like.

The insulating layer is made of any electrically insulating material. Examples of the material include an epoxy resin, an acrylic resin, polyurethane, polyimide, polyamide-imide, polyester imide, nylon, polyester, polyvinyl formal, and a synthetic resin in which at least two of the above resins are mixed.

Although the wire 301 of the coil portion 201 is a round wire whose conductor portion has a circular sectional shape in the present embodiment, the wire 301 is not limited to a round wire and may be other wires, such as a wire having a rectangular sectional shape and a flat wire. The conductor portion of the wire 301 of the present embodiment has an outer diameter Φ1 (see FIG. 2D) determined so that the wire 301 has a sectional area of, for example, 1.96×10⁻¹¹ m² to 1×10⁻⁸ m² regardless of the sectional shape. Specifically, the outer diameter Φ1 may be 5 μm to 100 μm and may be 10 μm to 50 μm.

Although the shape of the coil portion 201 in a plane perpendicular to the winding axis of the coil portion 201 in the present embodiment is a rectangle (square frame shape) having gently curved, arc-shaped corners, the shape of the coil portion 201 viewed from the winding axis direction is not limited to such a shape and may be, for example, elliptical, oval, or a perfect circle.

At both ends of the wire 301 of the coil portion 201, the electrode terminals 501a and 501b are formed. The electrode terminals 501a and 501b include the respective terminal bodies 511a and 511b, the respective outward protrusions 541a and 541b formed at the terminal bodies 511a and 511b, and respective lead-out portions 581a and 581b connecting the coil portion 201 and the terminal bodies 511a and 511b. The terminal bodies 511a and 511b include the respective electrode surfaces (electrode terminal outer surfaces) 521a and 521b exposed from the main surface 101b to the outer side of the coil component 11. The outward protrusions 541a and 541b protrude from the respective electrode terminal outer surfaces 521a and 521b towards the outer side of the element body 101.

The electrode terminals 501a and 501b are formed by processing part drawn out from the coil portion 201 at both ends of the wire 301 of the coil portion 201. Both ends of the wire 301 of the coil portion 201, i.e., a winding start part and a winding end part of the wire 301, are disposed at near diagonal positions of the main surface 101b in an X-Y plane as shown in FIG. 2B and closer to the main surface 101b in the Z-axis direction (at a lower side in the Z-axis direction) as shown in FIG. 2A. The electrode terminals 501a and 501b are formed by processing end extremities of the wire 301 that continue from the winding start part and the winding end part.

Each of the terminal bodies 511a and 511b is, for example, a sheet-shaped member having a rectangular planar shape as shown in FIG. 2B and a small thickness as shown in FIG. 2A. Each of the terminal bodies 511a and 511b is formed by squeezing the wire 301. Consequently, in a cross section orthogonal to the extending direction of the wire 301, the terminal bodies 511a and 511b have a thickness thinner (smaller) than the outer diameter (minimum value of the conductor portion and also referred to as “thickness of the wire” when the conductor portion has a sectional shape other than a circle) of the conductor portion of the wire 301 of the coil portion 201, and have a width wider (larger) than the outer diameter (maximum value of the conductor portion and also referred to as “width of the wire” when the conductor portion has a sectional shape other than a circle).

In the present embodiment, as shown in FIG. 2D, a thickness T2 of the terminal bodies 511a and 511b is small with respect to the outer diameter Φ1 of the conductor portion of the wire 301. For example, the thickness T2 may be 50% or less (½ or less) of the outer diameter of the conductor portion of the wire 301, and a minimum value of the thickness T2 may be 5% or more ( 1/20 or more), 10% or more ( 1/10 or more), or 25% or more (¼ or more) of the outer diameter Φ1 of the conductor portion of the wire 301. Specifically, the thickness T2 of the terminal bodies 511a and 511b may be 3 μm to 60 μm, 5 μm to 60 μm, or 8 μm to 60 μm, when the outer diameter Φ1 of the conductor portion of the wire 301 is, for example, 5 μm to 100 μm.

Increasing the thickness T2 of the terminal bodies 511a and 511b can improve absolute strength of the electrode terminals 501a and 501b, prevent rupture of the electrode terminals 501a and 501b, and improve adhesion strength (shear strength) between the electrode terminals 501a and 501b and the element body 101.

A width (length in a direction orthogonal to the extending direction of the wire 301) L1 of the terminal bodies 511a and 511b is large with respect to the outer diameter Φ1 of the conductor portion of the wire 301. For example, the width L1 may be two or more times larger than the outer diameter Φ1 of the conductor portion of the wire 301 and may be six or less times larger than the outer diameter Φ1 of the conductor portion of the wire 301. Specifically, the width L1 of the terminal bodies 511a and 511b is, for example, 10 μm to 600 μm and may be as wide so that the electrode terminals 501a and 501b are apart by a distance of 100 μm or more in the X-axis direction at the bottom surface 101b.

The outward protrusions 541a and 541b are columnar members (linear members) having a rectangular sectional shape as shown in FIG. 1B and are formed by further bending respective outer edges, in the X-axis direction, of the terminal bodies 511a and 511b, which are formed by squeezing the wire 301, as shown in FIG. 2A. Consequently, in the present embodiment, as shown in FIG. 2D, a width T3 of the outward protrusions 541a and 541b is substantially the same as the thickness T2 of the terminal bodies 511a and 511b in the cross section orthogonal to the extending direction of the wire 301.

When the coil component 11 including such outward protrusions 541a and 541b is mounted on a substrate or the like, lower ends (lower surfaces in the Z-axis direction) of the outward protrusions 541a and 541b substantially touch the mounting surface of the substrate and are placed on the substrate. Consequently, the height of the coil component 11 from the surface of the substrate after mounting is the total of the height of the coil component 11 and a height L2 of the outward protrusions 541a and 541b.

When the coil component 11 including the outward protrusions 541a and 541b is mounted on the substrate or the like, a joining member (e.g., solder) for joining the coil component 11 to the substrate adheres between the electrode terminal outer surfaces 521a and 521b and the substrate, and the outward protrusions 541a and 541b are embedded in the joining member.

Consequently, the height (protrusion length) L2 of the outward protrusions 541a and 541b is determined within a range in which the coil component 11 satisfies height reduction conditions required when it is mounted on the substrate or the like and a range in which the joining member (e.g., solder) applied to the electrode terminals 501a and 501b is under appropriate conditions. For example, the height L2 is determined under conditions in which an appropriate solder fillet is formed with respect to the electrode terminals 501a and 501b. Specifically, the height L2 of the outward protrusions 541a and 541b may be 0.5 to 10 times the thickness T2 of the terminal bodies 511a and 511b and may be 1 to 5 times the thickness T2.

The outward protrusions 541a and 541b may have a structure in which members different from the terminal bodies 511a and 511b are placed on the electrode terminal outer surfaces 521a and 521b. In this case, the width T3 of the outward protrusions 541a and 541b may be any width regardless of the thickness T2 of the terminal bodies 511a and 511b. The thickness of the outward protrusions may be thicker toward a tip thereof. Additionally, the sectional shape of the outward protrusions 541a and 541b is not limited to a rectangle and may be any shape. For example, it may be the shape shown in FIG. 2E. Moreover, the shape of the outward protrusions 541a and 541b in a plane is not limited to a linear shape running along the edges of the electrode terminal outer surfaces 521a and 521b and may be any shape. Further, the outward protrusions 541a and 541b may be placed at any location of the electrode terminal outer surfaces 521a and 521b. The number of the outward protrusions placed at one terminal body 511a or one terminal body 511b is not limited to one and may be plural.

The lead-out portions 581a and 581b are drawn towards the main surface 101b from a bottom surface (which is on the main surface 101b side) of the coil portion 201 as shown in FIG. 2A. This structure allows the lead-out portions 581a and 581b to be disposed inside a region occupied by the coil portion 201 in the mounting surface (X-Y plane), enabling reduction of the size of the coil component 11 in a horizontal direction (in a plane parallel to the mounting surface).

The terminal bodies 511a and 511b are disposed between the bottom surface (which is on the main surface 101b side) of the coil portion 201 and the main surface 101b as shown in FIG. 2A. This structure allows the terminal bodies 511a and 511b to be disposed inside the region occupied by the coil portion 201 in the mounting surface (X-Y plane), enabling reduction of the size of the coil component 11 in the horizontal direction (in the plane parallel to the mounting surface). Also, the equivalent series resistance (ESR) of the coil component 11 can be reduced.

The terminal bodies 511a and 511b are disposed at substantially facing locations at both sides in the longitudinal direction (X-axis direction) of the main surface 101b as shown in FIG. 2B. However, arrangement of the terminal bodies 511a and 511b in the plane (X-Y plane) parallel to the mounting surface is not limited thereto, and the terminal bodies 511a and 511b may be disposed in any arrangement that falls within the region where the coil portion 201 is disposed and ensures insulation between the two terminal bodies 511a and 511b.

The terminal bodies 511a and 511b include the respective outer surfaces (first main surfaces) 521a and 521b, which are formed along the bottom surface 101b of the element body 101 so as to be exposed to the outer side of the coil component 11, and respective inner surfaces (second main surfaces) 531a and 531b, which are opposite the outer surfaces 521a and 521b and are oriented towards the inside of the coil component 11 to firmly adhere to the element body 101. Although the electrode terminals 501a and 501b are, as explained above, composed of the wire 301 having been processed, at the locations of the terminal bodies 511a and 511b (and the outward protrusions 541a and 541b), the insulating layer at the outer periphery side of the wire 301 is removed, and the conductor portion of the wire 301 is exposed.

In the present embodiment, the electrode terminal outer surfaces 521a and 521b are formed so that they are flush with the main surface 101b of the coil component 11 (as flat surfaces forming the same plane). However, the electrode terminal outer surfaces 521a and 521b may be formed so that they protrude from the main surface 101b or so that they are recessed from the main surface 101b. Also, the electrode terminal outer surfaces 521a and 521b may have uneven surface roughness. In any of these forms, the outward protrusions 541a and 541b may protrude more to the outer side than the main surface 101b of the element body 101.

At the electrode terminal outer surfaces 521a and 521b of the terminal bodies 511a and 511b having the exposed conductor portion, plating films 561a and 561b are formed respectively. The plating films 561a and 561b may be composed of metal, such as Sn, Au, Cu, Ni, Pt, Ag, and Pd, or an alloy containing at least one of these metal elements formed into a film shape by plating. This type of film may be formed by other methods, such as sputtering. The plating films 561a and 561b have a thickness of, for example, 50 μm or less.

Forming such plating films 561a and 561b improves flatness of the electrode terminal outer surfaces 521a and 521b and increases bondability or wettability of the joining member (e.g., solder and conductive adhesive) for mounting the coil component 11 on the substrate or the like, allowing for solid connection via the electrode terminals 501a and 501b, i.e., solid mounting of the coil component 11. However, the plating films 561a and 561b are not necessarily formed. Also, similarly to the electrode terminal outer surfaces 521a and 521b, plating films may be formed on the outward protrusions 541a and 541b. Alternatively, even when the plating films are formed on the electrode terminal outer surfaces 521a and 521b, plating films do not have to be formed on the outward protrusions 541a and 541b.

The electrode terminals 501a and 501b are disposed between the bottom surface of the coil portion 201 and the main surface (bottom surface) 101b of the element body 101. That is, in the plane (X-Y plane) parallel to the mounting surface, the terminal bodies 511a and 511b and the lead-out portions 581a and 581b are disposed in the region where the coil portion 201 is disposed. This allows for a smaller size of the coil component 11.

For such arrangement, the terminal body may extend in the planar shape along the main surface in a direction towards a center of the electric element. The lead-out portions 581a and 581b are disposed so that the wire 301 extends away from outer sides of the coil portion 201 (outer sides in the X-axis direction) towards an inner side thereof (inner side in the X-axis direction) (e.g., towards the winding axis of the air core coil) as shown in FIG. 2A. Then, at the inner side of the coil portion 201, the wire 301 is bent towards the main surface 101b of the element body 101 (in the Z-axis direction) to connect to the terminal bodies 511a and 511b disposed along the main surface 101b.

More specifically, as shown in FIG. 2F, the lead-out portions 581a and 581b extend from respective lower corners of the air core coil 201 towards the inner side in the X-axis direction along the wound wire 301 (wire of the air core coil 201), are bent downwards in the Z-axis direction at respective locations away by a length L4 (center-to-center distance of the wire) towards the inner side, and are connected to the respective terminal bodies 511a and 511b.

Consequently, the terminal bodies 511a and 511b are solidly disposed between the bottom surface of the coil portion 201 and the bottom surface 101b of the element body 101 and may be disposed within the region occupied by the coil portion 201 in the mounting surface (X-Y plane).

The length L4, which is the length of the wire 301 as the lead-out portions 581a and 581b disposed towards a center side of the coil portion 201, may be any length. However, at the maximum, the length L4 is as long as a distance at which insulation between the two terminal bodies 511a and 511b facing each other in the X-axis direction can be ensured, i.e., a distance at which the two terminal bodies 511a and 511b are not too close to each other.

At the minimum, the length L4, which is the length of the wire 301 disposed towards the inner side, is as long so that edges of the terminal bodies 511a and 511b substantially match those of the air core coil 201 in the X-axis direction, which is L5 shown in FIG. 2G. Even with such a structure, provided that the terminal bodies 511a and 511b are disposed below the coil portion 201 in the Z-axis direction, need for increasing the size of the coil component 11 for the electrode terminals 501a and 501b is eliminated, and the coil component 11 can have a smaller size.

As shown in FIG. 2H, in the width direction (X-axis direction) of the terminal body 511a (511b), a location 591a where the lead-out portion 581a (581b) is formed with respect to the terminal body 511a (511b) (a lead-out formation location, a location of a center of the lead-out portion 581a (581b)) is substantially a center of the terminal body 511a (511b) in the width direction (X-axis direction). That is, a ratio L6:L7 is, for example, 40:60 to 60:40, where L6 is the length between the lead-out formation location 591a and an outer-side edge of the terminal body 511a (511b) in the width direction (X-axis direction) and L7 is the length between the lead-out formation location 591a and an inner-side edge of the terminal body 511a (511b) in the width direction.

However, for example, as shown in FIG. 2I, by disposing the lead-out formation location 591a more to an outer side of the center of the terminal body 511a (511b) in the width direction, a ratio L8:L9 may satisfy 10:90 to 40:60, where L8 is the length between the lead-out formation location 591a and the outer-side edge of the terminal body and L9 is the length between the lead-out formation location 591a and the inner-side edge of the terminal body. Such a structure allows the terminal bodies 511a and 511b to be disposed within the region below the coil portion 201 in the Z-axis direction while reducing the length L4 (or L5), which is the length of the lead-out portions 581a and 581b routed inwards with reference to FIGS. 2F and 2G. Further, such a structure can reduce the length of the lead-out portions 581a and 581b extending inwards along winding part of the coil portion 201 and reduce impacts on coil characteristics by the lead-out portions 581a and 581b.

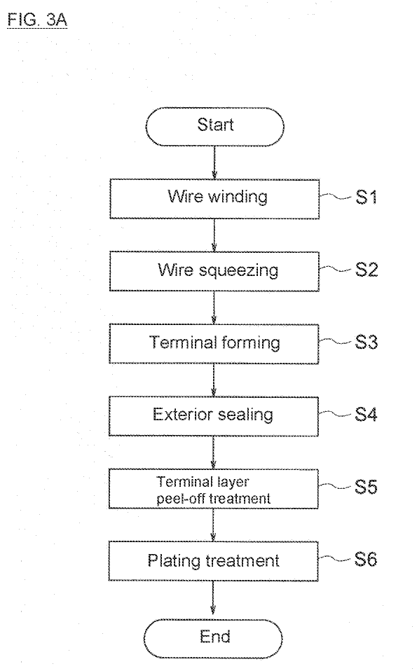

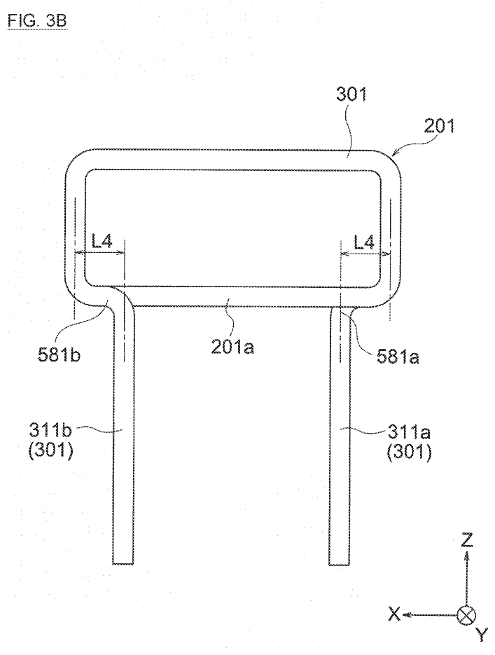

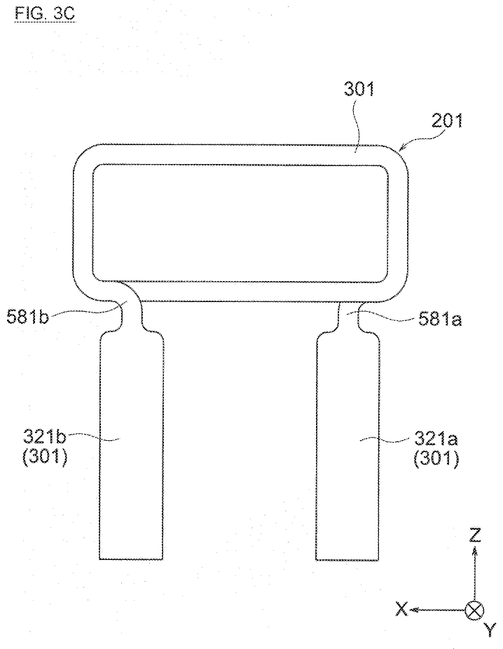

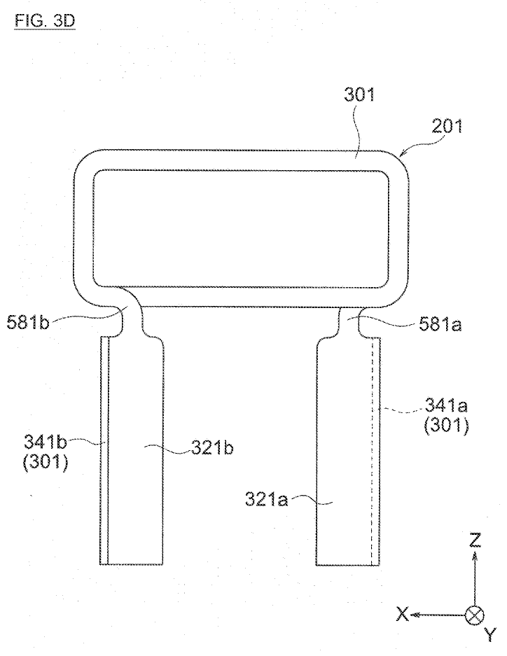

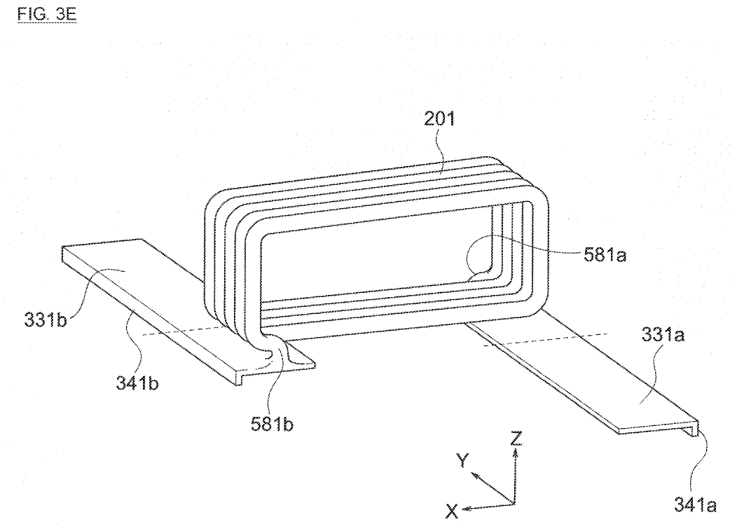

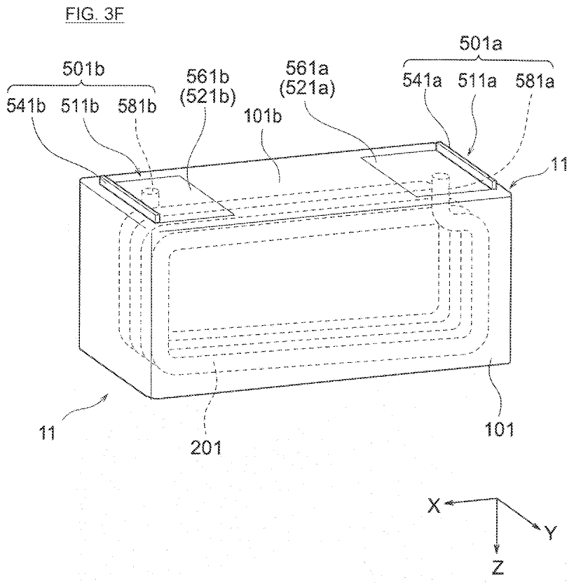

A method of manufacturing the coil component 11 will be explained next with reference to FIGS. 3A to 3F.

In manufacture of the coil component 11, first, the wire 301 is wound with a winding apparatus (not illustrated in the drawings) to form the air core coil 201 shown in FIG. 3B (step S1). Wire ends 311a and 311b of the wire 301, which has been wound, are extended inwards (towards the inner side in the X-axis direction) by the predetermined length L4 along a lower-side (in the Z-axis direction) portion 201a of the air core coil 201. Then, the wire ends 311a and 311b are bent towards the outside (downwards in the Z-axis direction) substantially at a right angle. A predetermined length of the wire ends 311a and 311b is secured, and the wire ends 311a and 311b are cut. At this stage, boundaries between the air core coil 201 and the wire ends 311a and 311b are formed as the lead-out portions 581a and 581b.

The wire ends 311a and 311b are then squeezed (flattened, pressed) as shown in FIG. 3C to form squeezed portions 321a and 321b having a sheet shape (step S2). Squeezing is performed by disposing the wire ends 311a and 311b of the wire 301 between top and bottom punches (of a convex tool) or pushing the wire ends 311a and 311b against a predetermined mold and pressing them. At this time, appropriate selection of a frame or a mold, appropriate determination of pressing intensity, appropriate post processing (e.g., cutting after squeezing), or the like can give the squeezed portions 321a and 321b having a desired stretch rate, stretch length, squeeze thickness, squeeze rate, or shape.

At the time of squeezing, for example, by disposing the wire 301 substantially at a center of the mold in its width direction and pressing it with uniform pressure applied in the width direction, the terminal bodies 511a and 511b having a ratio L6:L7 of substantially 50:50 may be formed as shown in FIG. 2H, where L6 and L7 are widths of both sides of the terminal body 511a (511b) where the lead-out formation location 591a is the center.

In contrast, at the time of squeezing, by pressing the wire 301 under the condition that a wall-shaped member is disposed on one side of the wire 301 or under the condition that the wire 301 is disposed at an off-centered location in the mold in its width direction, or by pressing the wire 301 in a certain diagonal direction, the terminal bodies 511a and 511b having a widthwise imbalanced form with respect to the lead-out formation location 591a to have a ratio L8:L9 of substantially 20:80 may be formed as shown in FIG. 2I, where L8 and L9 are widths of both sides of the terminal body 511a (511b) where the lead-out formation location 591a is the center.

After squeezing, the electrode terminals 501a and 501b are formed (“forming”) next (step S3). First, as shown in FIG. 3D, both ends of the squeezed portions 321a and 321b in the X-axis direction are bent at a predetermined width to form outward bent portions 341a and 341b. Because the outward bent portions 341a and 341b are portions that become the outward protrusions 541a and 541b, the width by which the outward bent portions 341a and 341b are bent is substantially the same as the height L2 of the outward protrusions 541a and 541b of the coil component 11. The outward bent portions 341a and 341b are bent in respective directions so that the outward bent portions 341a and 341b protrude opposite the coil portion 201 when the squeezed portions 321a and 321b are folded towards the lower side of the coil portion 201.

After the outward bent portions 341a and 341b are formed, as shown in FIG. 3E, the squeezed portions 321a and 321b are bent so that their respective end sides pass below the air core coil 201 to extend towards opposite sides, and excessive portions 331a and 331b are cut. Thereby the electrode terminals 501a and 501b are formed.

The step S2 (wire squeezing) and formation of the outward bent portions 341a and 341b in the step S3 (terminal forming) may be carried out simultaneously. By disposing the wire ends 311a and 311b in a mold having a shape of the squeezed portions 321a and 321b and the outward bent portions 341a and 341b and pressing them, they can be formed collectively.

Further, steps as far as cutting the excessive portions 331a and 331b in the step S3 (terminal forming) may be carried out simultaneously. By disposing the wire ends 311a and 311b in a mold having a shape of the squeezed portions 321a and 321b and the outward bent portions 341a and 341b and a size that does not include the excessive portions and pressing them, they can be formed collectively.

In the step S3 (terminal forming), either bending of the squeezed portions 321a and 321b or cutting of the excessive portions 331a and 331b may be carried out prior to the other.

The air core coil 201 is then encased in the element body 101 (exterior sealing) (step S4). Exterior sealing of the air core coil 201 is performed by, for example, arranging a plurality of coil portions 201 in a mold frame, injecting a resin into the mold frame and hardening the resin, and then singulating the molded coil portions 201. Because the terminal bodies 511a and 511b have a sheet shape, the electrode terminals 501a and 501b, which have been formed in the previous step, can stand on their own when the terminal bodies 511a and 511b are positioned at the lower side, and the coil portions 201 can be easily arranged in the exterior sealing step. Cutting into individual coil components may be performed immediately after the exterior sealing step or may be performed after a terminal layer peel-off treatment step (explained later) or a plating treatment step (explained later).

After each coil portion 201 is encased by the resin (after exterior sealing), the terminal layer peel-off treatment is performed (step S5). On the electrode terminal outer surfaces 521a and 521b and surfaces of the outward protrusions 541a and 541b, there may be a remaining insulating layer covering the conductor portion of the wire 301, adhesion of the insulating layer of the wire 301 that has adhered at the time of squeezing, or adhesion of sealing resin that has adhered at the time of exterior sealing. Thus, the resin adhered to the outer surfaces 521a and 521b of the electrode terminals 501a and 501b and the surfaces of the outward protrusions 541a and 541b is removed by, for example, polishing with a blade or laser irradiation to ensure that the electrode terminal outer surfaces 521a and 521b and the surfaces of the outward protrusions 541a and 541b are exposed to the outside. In this step, part of the main surface (bottom surface) 101b other than the outward protrusions 541a and 541b may be smoothed by, for example, simultaneously polishing the main surface 101b of the element body 101 entirely. The terminal layer peel-off treatment may be performed before squeezing of the wire ends. In this case, through the exterior sealing step in which the air core coil 201 is encased in the element body 101, the element body can be formed to cover the electric element so that the outer surfaces of the electrode terminals are exposed. To ensure exposure of the outer surfaces of the electrode terminals, the resin covering the outer surfaces of the electrode terminals may be removed (peeled off) after the exterior sealing step by, for example, further polishing with the blade or laser irradiation.

The plating films 561a and 561b are then formed (step S6) as shown in FIG. 3F on the outer surfaces 521a and 521b appropriately exposed to the main surface 101b of the element body 101 and on the outward protrusions 541a and 541b as necessary. When there is no need to form the plating films 561a and 561b, it may be that the plating treatment is not performed.

The coil component 11 can be manufactured with such a method.

In this manner, the outward protrusions 541a and 541b are formed at the respective electrode terminals 501a and 501b of the coil component 11 of the present embodiment. Thus, when the coil component 11 is mounted on a substrate using a joining member (e.g., solder), the outward protrusions 541a and 541b dig into the joining member to exhibit so-called anchor effects. Also, the surface area where the electrode terminals 501a and 501b and the joining member join is increased. Consequently, the mounting reliability of the coil component 11 on the substrate or the like can be improved.

Because the electrode terminals 501a and 501b of the coil component 11 of the present embodiment include the outward protrusions 541a and 541b structured by bending the ends of the terminal bodies 511a and 511b, the electrode terminals 501a and 501b have high hardness. Consequently, the coil component 11 has high hardness, which allows for improvement of its mechanical strength and maintenance of its characteristics despite the small size of the coil component 11, thereby enabling improvement of reliability of the coil component 11. Increase of the hardness of the coil component 11 makes it difficult for the electrode terminals 501a and 501b to peel off from the joining member (e.g., solder). Also in this respect, the bondability and the mounting reliability of the coil component 11 increase, which allows for improvement of the reliability of the coil component 11.

These effects are particularly effective for small coil components (electronic components), such as the coil component 11 of the present embodiment.

In the coil component 11 of the present embodiment, because the lead-out portions 581a and 581b are drawn out from the lower side of the coil portion 201 to connect to the electrode terminals 501a and 501b, the lead-out portions 581a and 581b do not need to be disposed over to the outer side of the region where the coil portion 201 is formed. Also in this respect, the coil component 11 can be reduced in size.

Such a structure of the lead-out portions 581a and 581b allows the lead-out portions 581a and 581b to be shortened. Thus, a resistive component of the lead-out portions 581a and 581b can be reduced, and the Q factor of the coil component 11 can be increased. The equivalent series resistance (ESR) of the coil component 11 can also be reduced. Such a coil component 11 is particularly effective as a coil component used at high frequencies.

In the coil component 11 of the present embodiment, because the electrode terminals 501a and 501b are formed by squeezing the ends of the wire 301 of the coil portion 201, there are no separate members for connecting the coil portion 201 and the electrode terminals 501a and 501b, and the electric element and the electrode terminals are integrally and continuously structured without boundaries (seamlessly). Consequently, the structure can be simple; the size can be reduced; and the manufacturing steps can be easy. Also in this respect, the resistive component of the coil component 11 can be reduced; its Q factor can be increased; and its equivalent series resistance (ESR) can be reduced. Also, because the possibility of connection failures between the electric element and the electrode terminals is eliminated, it is possible to provide a coil component having less failures and high reliability with long life.

### Second Embodiment

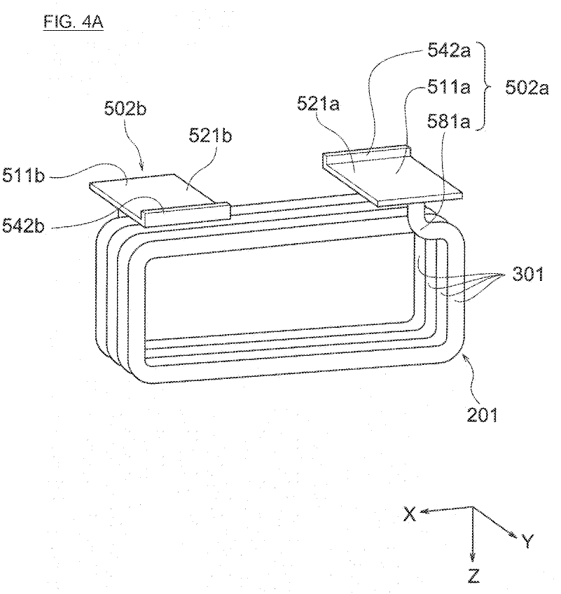

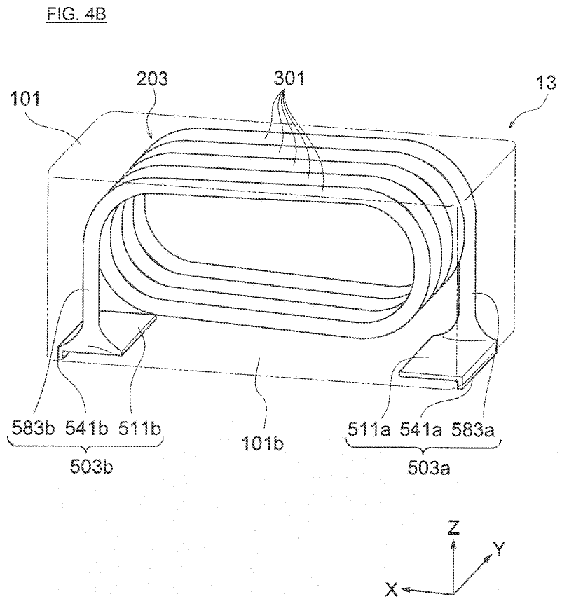

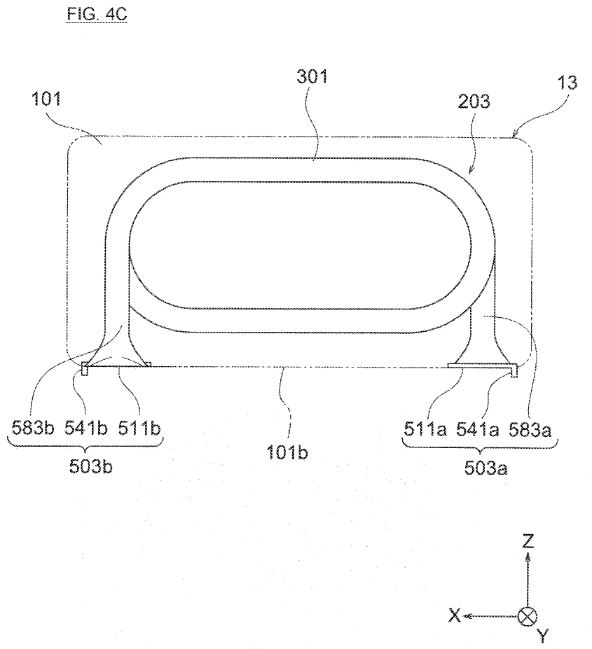

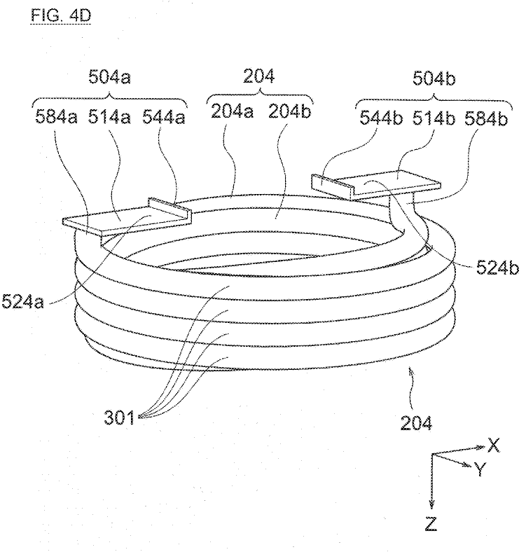

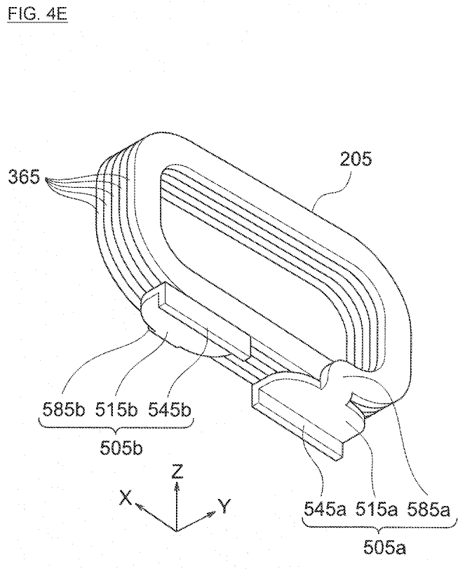

A coil component of a second embodiment will be explained with reference to FIG. 4A.

In description of the following second to ninth embodiments and other modified examples, structures common to the coil component 11 of the first embodiment are given the same reference numerals as in the first embodiment, and their detailed description is omitted. Difference from the first embodiment will be explained.

FIG. 4A illustrates the coil portion 201 and electrode terminals 502a and 502b of the coil component of the second embodiment. As shown in the drawing, the coil component of the second embodiment is different from the coil component 11 of the first embodiment in respect of the structure of the electrode terminals 502a and 502b.

In the electrode terminals 502a and 502b of the second embodiment, outward protrusions 542a and 542b extending in the X-axis direction are disposed along one and the other edges in the Y-axis direction of the terminal bodies 511a and 511b. That is, the outward protrusion 542a of the electrode terminal 502a on the right of the drawing is placed along the edge of the electrode terminal outer surface 521a at a deeper side of the drawing (deeper side in the Y-axis direction); and the outward protrusion 542b of the other electrode terminal 502b on the left of the drawing is placed along the edge of the electrode terminal outer surface 521b at a nearer side of the drawing (nearer side in the Y-axis direction). The outward protrusions 542a and 542b may be arranged in such a form with respect to the terminal bodies 511a and 511b.

Other structures are substantially the same as those of the coil component 11 of the first embodiment. For example, the electrode terminals 502a and 502b of the coil component of the second embodiment are also formed by squeezing both ends of the wire 301 of the air core coil 201. Consequently, the coil component of the second embodiment also exhibits the same effects as the coil component 11 of the first embodiment does.

### Third Embodiment

A coil component 13 of the third embodiment will be explained with reference to FIGS. 4B and 4C.

The coil component 13 of the third embodiment includes the element body 101, an air core coil 203, and a pair of electrode terminals 503a and 503b. The electrode terminals 503a and 503b include the terminal bodies 511a and 511b, lead-out portions 583a and 583b, and the outward protrusions 541a and 541b, respectively.

The lead-out portions 583a and 583b of the coil component 13 of the third embodiment have a structure different from that of the lead-out portions 581a and 581b of the coil component 11 of the first embodiment. As shown in FIGS. 4B and 4C, the lead-out portions 583a and 583b of the coil component 13 of the third embodiment extend from both ends (the winding start part and the winding end part) of the wire 301 of the air core coil 203 at outer sides in the X-axis direction straight to the main surface 101b side (lower side in the Z-axis direction) and connect (continue) to the terminal bodies 511a and 511b. That is, the lead-out portions 583a and 583b of the coil component 13 of the third embodiment do not have part extending inwards from the outer sides in the X-axis direction of the coil portion 203.

Consequently, the structure of the lead-out portions 583a and 583b of the coil component 13 of the third embodiment can be simple.

Although the terminal bodies 511a and 511b of the coil component 13 of the third embodiment are disposed so as to stick out from the region where the air core coil 203 is present in the plane (X-Y plane) parallel to the mounting surface, degree of the sticking out may be reduced or eliminated. For such purposes, a location (lead-out formation location) of the lead-out portion 583a (583b) with respect to the terminal body 511a (511b) may be off-centered to the outer side in the width direction of the terminal body 511a (511b), for example, as mentioned previously with reference to FIG. 2I.

Other structures are substantially the same as those of the coil component 11 of the first embodiment or the coil component of the second embodiment. For example, the electrode terminals 503a and 503b of the coil component 13 of the third embodiment are also formed by squeezing both ends of the wire 301 of the air core coil 203. Consequently, the coil component 13 of the third embodiment also exhibits the same effects as the coil component 11 of the first embodiment or the coil component of the second embodiment does.

### Fourth Embodiment

A coil component of the fourth embodiment will be explained with reference to FIG. 4D.

FIG. 4D illustrates a coil portion 204 and electrode terminals 504a and 504b of the coil component of the fourth embodiment. The coil component of the fourth embodiment has a structure in which a winding axis of the coil portion 204 is disposed so as to be perpendicular to the mounting surface.

The coil component of the fourth embodiment includes the element body (not shown in the drawing), the coil portion 204, and the pair of electrode terminals 504a and 504b. The electrode terminals 504a and 504b include terminal bodies 514a and 514b, lead-out portions 584a and 584b, and outward protrusions 544a and 544b, respectively.

The coil portion 204 includes an outer winding part 204a and an inner winding part 204b, which are composed of one wire 301 wound in two (inner and outer) layers. One end of the wire 301 is drawn out from a lower portion (main surface side) of the outer winding part 204a towards the outside of the coil portion 204, and the other end of the wire 301 is drawn out from a lower portion (main surface side) of the inner winding part 204b towards the outside of the coil portion 204. The outer winding part 204a and the inner winding part 204b are continued (connected) at an upper portion (in the Z-axis direction) of the coil portion 204.

One end of the wire 301 drawn out from the lower portion of the outer winding part 204a constitutes the lead-out portion 584a of the electrode terminal 504a, and the other end of the wire 301 drawn out from the lower portion of the inner winding part 204b constitutes the lead-out portion 584b of the other electrode terminal 504b. The lead-out portions 584a and 584b continue to the respective terminal bodies 514a and 514b disposed along the main surface of the element body of the coil component.

Arrangement of the electrode terminals 504a and 504b in the mounting surface (X-Y plane), i.e., arrangement of the air core coil 204 in a plane perpendicular to the winding axis of the air core coil 204, may be placed at any location within the region occupied by the coil portion 204 in the mounting surface. For example, as shown in FIG. 4D, the two electrode terminals 504a and 504b may be disposed to face each other along the X-axis direction, substantially at a center in the Y-axis direction of the region occupied by the coil portion 204 in the mounting surface.

At electrode terminal outer surfaces 524a and 524b of the respective electrode terminals 504a and 504b, the respective outward protrusions 544a and 544b are formed. In the present embodiment, as shown in FIG. 4D, the outward protrusions 544a and 544b extending in the Y-axis direction are disposed along opposing inner edges of the terminal bodies 514a and 514b facing each other along the X-axis direction. However, arrangement of the outward protrusions 544a and 544b is not limited thereto, and the outward protrusions 544a and 544b may be disposed at any locations on the terminal bodies 514a and 514b.

Because the coil portion 204 of the coil component of the fourth embodiment is disposed so that the winding axis of the coil portion 204 is perpendicular to the mounting surface (horizontal placement), such arrangement is particularly effective for height reduction of the electronic component. Moreover, because the region of the coil portion 204 with respect to the mounting surface, i.e., the region where the electrode terminals 504a and 504b are disposed, is widened, degree of freedom in disposing the electrode terminals 504a and 504b is improved.

Other structures are substantially the same as those of the coil components of the first to third embodiments. For example, the electrode terminals 504a and 504b of the coil component of the fourth embodiment are also formed by squeezing both ends of the wire 301 of the air core coil 204. Consequently, the coil component of the fourth embodiment also exhibits the same effects as the coil components of the first to third embodiments do.

### Fifth Embodiment

A coil component of the fifth embodiment will be explained with reference to FIG. 4E.

FIG. 4E illustrates a coil portion 205 and electrode terminals 505a and 505b of the coil component of the fifth embodiment. The coil component of the fifth embodiment has a structure in which the coil portion 205 is made of an air core coil formed of a rectangular wire 365 that is edgewise wound.

The coil component of the fifth embodiment includes the element body (not shown in the drawing), the coil portion 205, and the pair of electrode terminals 505a and 505b. The electrode terminals 505a and 505b include terminal bodies 515a and 515b, lead-out portions 585a and 585b, and outward protrusions 545a and 545b, respectively.

The coil portion 205 has a structure in which the rectangular wire 365 is edgewise wound and accommodated in the element body so that the winding axis of the rectangular wire 365 is parallel to the mounting surface (vertical placement). Both ends of the rectangular wire 365 extend from outer sides of the coil portion 205 in the X-axis direction towards an inner side thereof, are bent at center-side locations of the coil component towards the mounting surface (main surface side), and are connected (continued) to the terminal bodies 515a and 515b.

The electrode terminals 505a and 505b of the coil component of the fifth embodiment are also formed by squeezing both ends of the rectangular wire 365 of the air core coil 205.

In squeezing of the rectangular wire 365, squeezing may be performed in a cross section orthogonal to the extending direction of the rectangular wire 365 so that a post-squeezing width of the rectangular wire (squeezed portions) is, for example, at least twice as large as a pre-squeezing width of the rectangular wire 365. Squeezing may be performed in the cross section so that the post-squeezing width is 2.5 to 6 times the pre-squeezing width of the rectangular wire 365. A post-squeezing thickness of the rectangular wire (squeezed portions) may be smaller than a pre-squeezing thickness of the rectangular wire 365. For example, the post-squeezing thickness may be 50% or less (½ or less) of the pre-squeezing thickness. Squeezed portions 375a and 375b may have a minimum thickness that is 5% or more ( 1/20 or more), 10% or more ( 1/10 or more), or 25% or more (¼ or more) of the pre-squeezing thickness of the rectangular wire 365. a ratio (thickness:width) between the thickness and the width of the squeezed portions may be 1:5 to 1:15.

Other structures of such a coil component including the rectangular wire 365 are substantially the same as those of the coil components of the first to fourth embodiments. Consequently, the coil component of the fifth embodiment also exhibits the same effects as the coil components of the first to fourth embodiments do.

### Sixth Embodiment

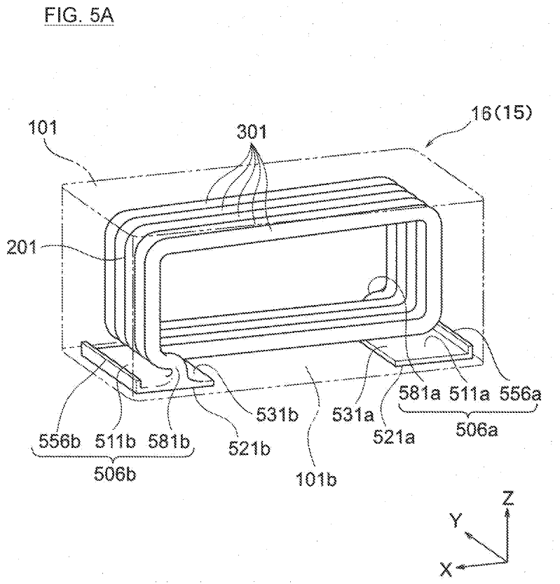

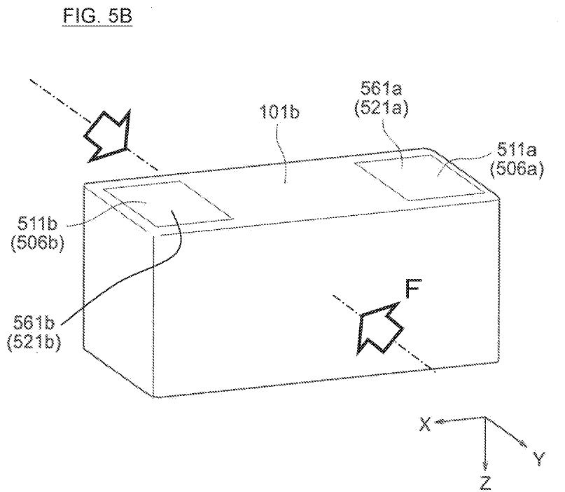

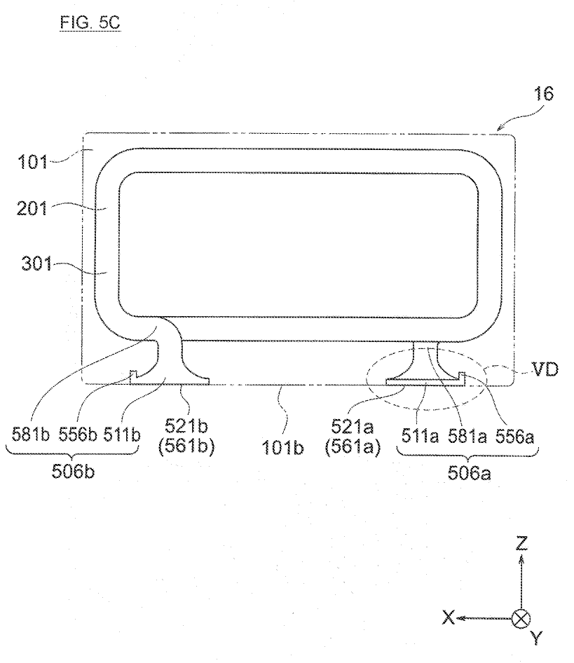

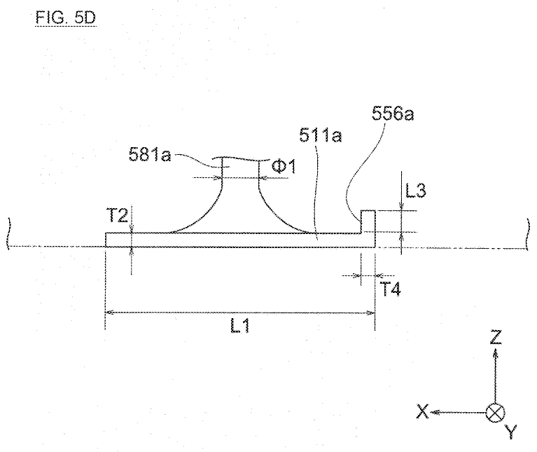

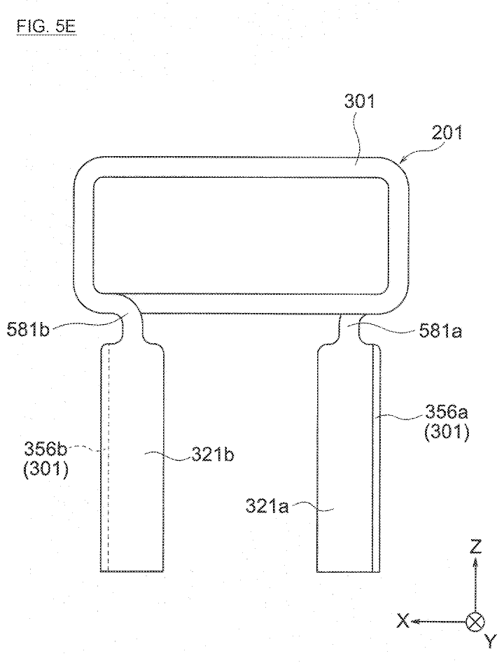

A coil component 16 of the sixth embodiment will be explained with reference to FIGS. 5A to 5E.

The coil component 16 of the sixth embodiment is a coil component in which the terminal bodies 511a and 511b of electrode terminals 506a and 506b are provided with inward protrusions 556a and 556b protruding towards an inner side of the element body 101.

As shown in FIG. 5A, the coil component 16 includes the element body 101, the air core coil (coil portion) 201 as an electric element, and the pair of electrode terminals 506a and 506b formed at both ends of the wire 301 of the coil portion 201. The electrode terminals 506a and 506b include the terminal bodies 511a and 511b, the inward protrusions 556a and 556b formed at the respective terminal bodies 511a and 511b, and the lead-out portions 581a and 581b connecting the coil portion 201 and the terminal bodies 511a and 511b, respectively.

The terminal bodies 511a and 511b of the electrode terminals 506a and 506b include the respective outer surfaces 521a and 521b, which are exposed from the main surface 101b to the outer side of the coil component 16, and the respective inner surfaces 531a and 531b, which are opposite the outer surfaces 521a and 521b, oriented towards the inside of the element body 101, and firmly adhered to the resin material forming the element body 101.

The inward protrusions 556a and 556b protrude from the respective inner surfaces 531a and 531b of the terminal bodies 511a and 511b towards the inner side of the element body 101. The inward protrusions 556a and 556b are formed along respective edges of the inner surfaces 531a and 531b at both sides in the X-axis direction (outermost edges in the X-axis direction that extend in the Y-axis direction), entirely across the inner surfaces 531a and 531b of the terminal bodies 511a and 511b in the Y-axis direction.

The inward protrusions 556a and 556b are columnar members (linear members) having a rectangular sectional shape and are formed by, as shown in FIG. 5A, bending at substantially 90 degrees the outer edges, in the X-axis direction, of the terminal bodies 511a and 511b, which are formed by squeezing the wire 301. Consequently, in the present embodiment, as shown in FIG. 5D, a width T4 of the inward protrusions 556a and 556b is substantially the same as the thickness T2 of the terminal bodies 511a and 511b in the cross section orthogonal to the extending direction of the wire 301. In some embodiments, the thickness of the inward protrusions may be thicker toward a tip thereof.

A height (protrusion length) L3 of the inward protrusions 556a and 556b may be any height at which the inward protrusions 556a and 556b do not touch the coil portion 201. For example, the height L3 of the inward protrusions 556a and 556b may be 0.5 to 10 times the thickness T2 of the terminal bodies 511a and 511b, and may be 1 to 5 times the thickness T2. Specifically, the height L3 of the inward protrusions 556a and 556b may be 2 μm to 10 μm.

Such inward protrusions 556a and 556b may be formed as the outward protrusions 541a and 541b are formed with reference to FIGS. 3A to 3F. That is, as shown in FIG. 5E, both ends of the squeezed portions 321a and 321b of the wire 301 in the X-axis direction are bent at a predetermined width to form inward bent portions 356a and 356b. Because the inward bent portions 356a and 356b are portions that become the inward protrusions 556a and 556b, the width by which the inward bent portions 356a and 356b are bent is substantially the same as the height L3 of the inward protrusions 556a and 556b of the coil component 16. The inward bent portions 356a and 356b are bent in respective directions so that the inward protrusions 556a and 556b protrude towards the coil portion 201 when the squeezed portions 321a and 321b are folded towards the lower side of the coil portion 201.

The angle at which the inward bent portions 356a and 356b are bent is not limited to substantially 90 degrees and may be larger than 90 degrees or smaller than 90 degrees as mentioned in the eighth embodiment described later. When the angle is larger than 90 degrees, the inward protrusions 556a and 556b are angled by an acute angle with respect to the terminal bodies 511a and 511b. When the angle is smaller than 90 degrees, the inward protrusions 556a and 556b are angled by an obtuse angle with respect to the terminal bodies 511a and 511b.

After the inward bent portions 356a and 356b are formed, the squeezed portions 321a and 321b are bent as mentioned previously with reference to FIG. 3E, and the excessive portions 331a and 331b are cut. Thereby the electrode terminals 506a and 506b including the inward protrusions 556a and 556b are formed.

Similarly to manufacture of the electrode terminals 501a and 501b including the outward protrusions 541a and 541b of the first embodiment, in manufacture of the inward protrusions 556a and 556b, the wire squeezing step and formation of the inward bent portions 356a and 356b may be carried out simultaneously; steps as far as cutting the excessive portions 331a and 331b may be carried out simultaneously; or either bending of the squeezed portions or cutting of the excessive portions in the step S3 (terminal forming) may be carried out prior to the other.

Because the coil component 16 of the present embodiment is not provided with the outward protrusions 541a and 541b, as shown in FIG. 5B, the main surface 101b of the element body 101 is formed as a flat surface. The main surface 101b is the mounting surface when the coil component 16 is mounted on a substrate or the like, and the electrode terminal outer surfaces 521a and 521b having the plating films 561a and 561b are exposed at the main surface 101b. However, the outward protrusions 541a and 541b may be formed on the coil component 16 of the present embodiment. That is, the electrode terminals having the inward protrusions may further have the outward protrusions that are integrally and continuously formed with the corresponding terminal bodies and protrude outside the main surface.

In this manner, the inward protrusions 556a and 556b are formed at the respective electrode terminals 506a and 506b of the coil component 16 of the sixth embodiment. Thus, when the element body 101 is sealed to encase the electrode terminals 506a and 506b, the inward protrusions 556a and 556b dig into the resin material of the element body 101 to exhibit so-called anchor effects, which can make it difficult for the electrode terminals 506a and 506b to come out from the element body (exterior resin) 101. Also, the surface area where the electrode terminals 506a and 506b and the resin material of the element body 101 join is increased. Consequently, bonding strength (adhesion strength) between the electrode terminals 506a and 506b and the element body 101 can be increased, which can prevent, for example, peeling of the electrode terminals 506a and 506b.

Because the electrode terminals 506a and 506b of the coil component 16 of the present embodiment include the inward protrusions 556a and 556b structured by bending the ends of the terminal bodies 511a and 511b, the electrode terminals 506a and 506b have high hardness. Consequently, the coil component 16 can have high hardness, which allows for improvement of its mechanical strength and maintenance of its characteristics despite the small size of the coil component 16, thereby enabling improvement of reliability of the coil component 16. Increase of the hardness of the coil component 16 makes it difficult for the electrode terminals 506a and 506b to peel off from a joining member (e.g., solder) when the coil component 16 is mounted on a substrate or the like. This allows for improvement of the bondability and the mounting reliability of the coil component 16.

Other structures of such coil component 16 of the sixth embodiment are substantially the same as those of the coil components of the first to fifth embodiments. Consequently, the coil component of the sixth embodiment also exhibits the same effects as the coil components of the first to fifth embodiments do.

### Seventh Embodiment

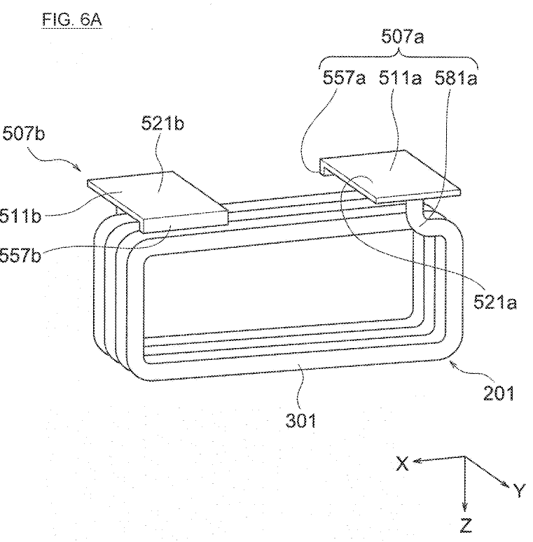

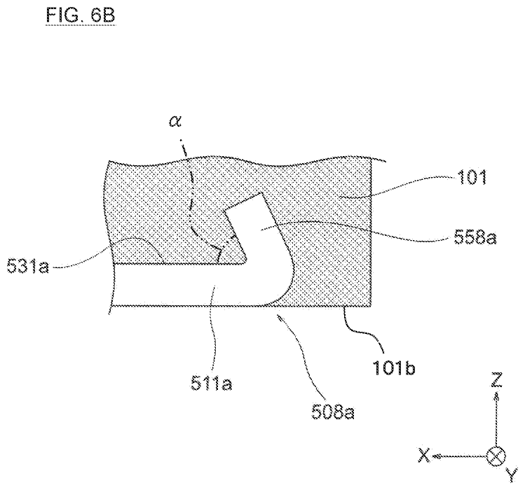

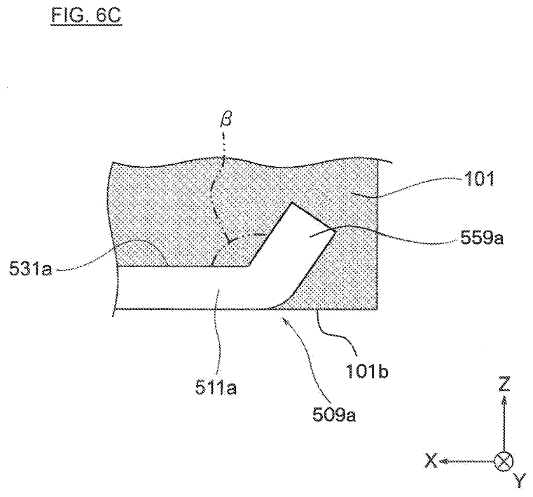

A coil component of the seventh embodiment will be explained with reference to FIG. 6A.

FIG. 6A illustrates the coil portion 201 and electrode terminals 507a and 507b of the coil component of the seventh embodiment. As shown in the drawing, the coil component of the seventh embodiment is different from the coil component of the sixth embodiment in respect of the structure of the electrode terminals 507a and 507b.

In the electrode terminals 507a and 507b of the seventh embodiment, inward protrusions 557a and 557b extending in the X-axis direction are disposed along one and the other edges in the Y-axis direction of the terminal bodies 511a and 511b. That is, the inward protrusion 557a of the electrode terminal 507a on the right of the drawing is placed along the edge of the inner surface 531a of the terminal body 511a at a deeper side of the drawing (deeper side in the Y-axis direction); and the inward protrusion 557b of the other electrode terminal 507b on the left of the drawing is placed along the edge of the inner surface 531b of the terminal body 511b at a nearer side of the drawing (nearer side in the Y-axis direction).

The inward protrusions 557a and 557b shown in FIG. 6A are formed by bending at substantially 90 degrees the tips of the terminal bodies 511a and 511b, which are formed by squeezing the wire. The inward protrusions 557a and 557b may be arranged in such a form with respect to the terminal bodies 511a and 511b.

Other structures are substantially the same as those of the coil components of the first to sixth embodiments. Consequently, the coil component of the seventh embodiment also exhibits the same effects as the coil components of the first to sixth embodiments do.

### Eighth Embodiment

A coil component of the eighth embodiment will be explained with reference to FIGS. 6B and 6C.

FIGS. 6B and 6C illustrate respective inward protrusions 558a and 559a formed at the terminal body 511a of respective electrode terminals 508a and 509a of the pair of electrode terminals. The inward protrusions 558a and 559a of the eighth embodiment protrude from the inner surface 531a of the terminal body 511a at an angle towards the inside of the element body 101.

The inward protrusion 558a shown in FIG. 6B is angled by an acute angle (a) with respect to the inner surface 531a of the terminal body 511a and protrudes towards the inside of the element body 101. The angle α at which the inward protrusion 558a is angled with respect to the inner surface 531a of the terminal body 511a is larger than 0 degrees and smaller than 90 degrees. For example, the angle may be 5 degrees to 85 degrees, 10 degrees to 80 degrees, 15 degrees to 75 degrees, or 30 degrees to 60 degrees. Such an inward protrusion 558a may be formed by bending at a desired angle larger than 90 degrees the tip of the terminal body 511a, which is formed by squeezing the wire.

The inward protrusion 559a shown in FIG. 6C is angled by an obtuse angle ((3) with respect to the inner surface 531a of the terminal body 511a and protrudes towards the inside of the element body 101. The angle β at which the inward protrusion 559a is angled with respect to the inner surface 531a of the terminal body 511a is larger than 90 degrees and smaller than 180 degrees. For example, the angle may be 95 degrees to 175 degrees, 100 degrees to 170 degrees, 105 degrees to 165 degrees, or 120 degrees to 150 degrees. The inward protrusion 559a shown in FIG. 6C may be formed by bending at a desired angle smaller than 90 degrees the tip of the terminal body 511a, which is formed by squeezing the wire.

When the element body 101 is sealed to encase the electrode terminal including the inward protrusions 558a, 559a having such a structure, the inward protrusions 558a, 559a engage with and digs into the resin material of the element body 101. In particular, because the inward protrusions 558a, 559a of the present embodiment are angled with respect to the inner surface 531a of the terminal body 511a to protrude towards the inside of the element body 101, the member (exterior resin) forming the element body 101 is present below the inward protrusions 558a, 559a (on the main surface 101b side in the Z-axis direction). Consequently, the inward protrusions 558a, 559a effectively resist force of pulling the element body 101 and the electrode terminals 508a, 509a apart (force of pulling out the electrode terminals) that is applied in the vertical direction (Z-axis direction). This allows for further firm bonding between the electrode terminal and the element body 101.

Other structures are substantially the same as those of the coil components of the first to seventh embodiments. Consequently, the coil component of the eighth embodiment also exhibits the same effects as the coil components of the first to seventh embodiments do.

### Ninth Embodiment

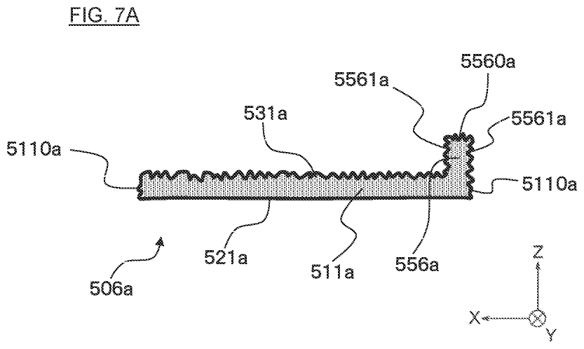

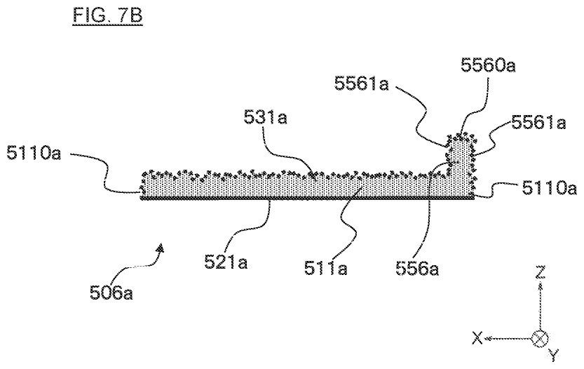

A coil component of the ninth embodiment will be explained with reference to FIGS. 7A and 7B.

The coil component of the ninth embodiment is a coil component in which surface roughness is different between the outer surfaces (first main surfaces) 521a and 521b and other surfaces (surfaces other than the outer surfaces) including the inner surfaces (second main surfaces) 531a and 531b of the terminal bodies 511a and 511b of the electrode terminals 506a and 506b of, for example, the coil component 16 shown in FIG. 5A. Although this structure (characteristic) is applicable to all coil components of the first to eighth embodiments in the same way, a coil component 15 in which this structure is applied to the coil component 16 of the sixth embodiment will be explained.

FIGS. 7A and 7B are schematic views of one electrode terminal 506a of the coil component 15 shown in FIG. 5A. FIG. 7A schematically illustrates a condition in which surfaces other than the outer surface 521a of the terminal body 511a of the electrode terminal 506a are roughened by a mechanical method (physical method). FIG. 7B schematically illustrates a condition in which the surfaces other than the outer surface 521a of FIG. 7A are further roughened by a chemical method (e.g., etching).

As shown in FIGS. 7A and 7B, the outer surface 521a of the terminal body 511a of the electrode terminal 506a is formed to be a flat surface, and the inner surface 531a thereof is formed to be a surface having predetermined surface roughness. That is, the inner surface 531a is formed to be a surface rougher than (having larger surface roughness than) the outer surface 521a.

Side surfaces 5110a (four side surfaces (of all directions) of the terminal body 511a having a substantially rectangular shape; the reference numeral 5110a is given only to the side surfaces facing each other in the X-axis direction in FIGS. 7A and 7B) of the terminal body 511a are also formed to be surfaces having the same predetermined surface roughness as the inner surface 531a. The electrode terminal 506a has the inward protrusion 556a, which is embedded in (digs into) the element body 101. An upper surface 5560a and side surfaces 5561a (four side surfaces of all directions; the reference numeral 5561a is given only to the side surfaces facing each other in the X-axis direction in FIGS. 7A and 7B) of the inward protrusion 556a are also formed to be surfaces having the same predetermined surface roughness as the inner surface 531a.

That is, in the coil component 15 of the present embodiment, the surfaces other than the outer surface (i.e., the inner surface 531a, the side surfaces 5110a of the terminal body 511a, the upper surface 5560a and the side surfaces 5561a of the inward protrusion 556a) are formed to be the surfaces rougher than the outer surface 521a. In other words, in the coil component 15 of the present embodiment, among surrounding surfaces of the electrode terminal 506a, the surfaces that are embedded into the element body 101 and are in contact with the resin (exterior resin) forming the element body are rougher than the outer surface 521a exposed outside the coil component 15. Specifically, the outer surface 521a of the terminal body 511a of the electrode terminal 506a may have an arithmetic average roughness Rz (JIS B 0601:2013) of 1 μm to 5 μm. The surfaces other than the outer surface 521a of the terminal body 511a of the electrode terminal 506a may have an arithmetic average roughness Rz (JIS B 0601:2013)) of 1 μm to 5 μm. Alternatively, the surfaces other than the outer surface 521a of the terminal body 511a of the electrode terminal 506a may be as smooth as 100% or more and 500% or less, 200% or more and 500% or less, or 300% or more and 500% or less.

By forming the outer surfaces 521a and 521b into the flat surfaces, quality of the plating films 561a and 561b (FIG. 5B) formed on the outer surfaces 521a and 521b can be improved. That is, the plating films 561a and 561b having high flatness can be formed without occurrence of plating peel-off or the like. Consequently, the bondability between the coil component 15 and an external circuit is improved, which can improve the reliability of the coil component 15 when it is mounted. Even when the plating films 561a and 561b are not formed on the electrode terminal outer surfaces 521a and 521b, the bondability between the electrode terminal outer surfaces 521a and 521b and a joining member or the external circuit can be improved.

By forming the surfaces of the terminal bodies 511a and 511b other than the outer surfaces (i.e., the surfaces that are in contact with the element body 101) into the rough surfaces, adhesion of these surfaces to the element body 101 can be improved. Consequently, the electrode terminals 506a and 506b and the element body 101 can be firmly bonded. In particular, because the element body 101 is formed of the resin material, forming the surfaces of the terminal bodies 511a and 511b in contact with the element body 101 into the rough surfaces improves the adhesion to exhibit so-called anchor effects, which allow for firm bonding between the electrode terminals 506a and 506b and the element body 101.

As mentioned earlier, the thickness T2 (FIGS. 2D and 5D) of the terminal body 511a is freely determined. When the thickness of the terminal body 511a is relatively large, i.e., 5 μm or more, the side surfaces 5110a (FIGS. 7A and 7B) of the terminal body 511a have a large area, which exhibit improved fastenability to the element body 101 once the side surfaces 5110a are roughened. In such a form, roughening the side surfaces 5110a of the terminal body 511a is effective.

Methods of forming such rough surfaces on the electrode terminals 506a and 506b may include mechanical (physical) methods (e.g., squeezing, knurling, and grinding), chemical methods (e.g., etching, chemical polishing, and electropolishing), and a combination of both in sequence (in two steps or step by step).

As a mechanical (physical) method, for example, punches having different surface roughness may be used on top and bottom to squeeze the wire 301 in the step S2 (squeezing) described previously with reference to FIG. 3A. That is, a punch whose contact surface with the wire 301 has high surface roughness is used as a punch that abuts sides that become the outer surfaces 521a and 521b; and a punch (a fine punch) whose contact surface with the wire 301 has low surface roughness is used as a punch that abuts sides that become the inner surfaces 531a and 531b. Alternatively, surface roughness of the front and the back of the squeezed portions 321a and 321b (FIG. 3C) may be changed by separately machine processing the front and the back after squeezing. At this time, the terminal layer peel-off treatment described previously may be performed before squeezing of the wire ends. In this case, desired squeezing can be performed efficiently in a short amount of time.

Through such mechanical roughening, the surfaces other than the outer surface 521a are roughened as shown in FIG. 7A. This can increase the surface area of the contact surface with the element body 101 and can improve adhesion between these surfaces and the element body 101. In particular, because the element body 101 is formed of the resin material, forming the surfaces other than the outer surface 521a of the terminal body 511a into the rough surfaces exhibits the anchor effects. Also in this respect, adhesion improves to allow for firm bonding between the terminal bodies 511a and 511b and the element body 101. Consequently, the electrode terminal 506a can be firmly bonded to the element body 101.

As a chemical method, for example, etching may be performed. For example, further performing etching on the surfaces physically roughened as shown in FIG. 7A can roughen these surfaces so as to make them finely uneven (so-called three-dimensional roughening) as schematically shown in FIG. 7B. This can further increase the surface area of the contact surface with the element body 101, further exhibit the anchor effects, and further improve the adhesion between the electrode terminal 506a and the element body 101.

During etching, the electrode terminal may be etched entirely, or freely selected spots of the electrode terminal may be etched (roughened) while spots not subject to roughening are appropriately masked. For example, the surfaces other than the outer surface 521a of the terminal body 511a may be etched easily by masking only the outer surface 521a of the terminal body 511a and performing etching.

Roughening of the surfaces of the electrode terminals 506a and 506b may be performed by only physical roughening or by only chemical roughening. Both may be performed in sequence (in two steps). Moreover, all surfaces (including the outer surfaces 521a and 521b) of the electrode terminals 506a and 506b may be roughened into predetermined roughness, and then the outer surfaces 521a and 521b may be polished or subjected to other treatments to be formed into fine flat surfaces, to make the surfaces other than the outer surfaces relatively rough.

Roughening is not required to be performed on all surfaces (all surfaces other than the outer surface 521a) of the electrode terminals 506a and 506b. For example, only the inner surfaces 531a and 531b, which are in contact with the element body 101 at a large contact area, may be roughened, or only the surrounding surfaces (side surfaces) 5110a, where the terminal bodies 511a and 511b readily peel off from the element body 101, may be roughened. Degree of roughening may differ among surfaces subject to roughening.

### OTHER MODIFIED EXAMPLES

The present disclosure is not limited to the above-mentioned embodiments and can variously be modified in any favorable manner.

For example, in each of the above-mentioned embodiments, the thickness of the terminal bodies of the electrode terminals is not required to be uniform, and the terminal bodies may have a thick portion or a thin portion. For example, although the electrode terminals shown in FIG. 5A and FIGS. 6A to 6C have the structure in which the inward protrusions 556a to 559a, which are formed by bending the tip of the terminal body 511a formed by squeezing the wire, dig into the element body 101, the plate thickness from the terminal body 511a to the tips of the inward protrusions 556a to 559a (portion ahead of where the plate is bent) may be larger than the thickness of the main region of the terminal body 511a. Alternatively, the plate thickness of where the plate is bent may be larger than the thickness of the terminal body 511a and the thickness of the tips of the inward protrusions 556a to 559a.

In this type of coil component, for example, as shown in FIG. 5B, it is important that the adhesion strength be exhibited against force F applied from a direction right-angled with respect to the direction (X-axis direction) in which the pair of electrode terminals 506a and 506b is aligned. In the coil component testing, the force is applied in this direction to test the adhesion strength. At this time, stress may be concentrated at the root (where the plate is bent) of the inward protrusions 556a and 556b (FIG. 5A) of the electrode terminals 506a and 506b, and the root may have weaker strength due to bending. In this regard, thickening the plate thickness of the root (where the plate is bent) of the inward protrusions 556a and 556b can reinforce the root (where the plate is bent) of the inward protrusions 556a and 556b. This improves the adhesion strength of the electrode terminals 506a and 506b, allowing for improvement of the adhesion strength as the coil components 15 and 16.

With regard to thickening the plate thickness from the terminal body 511a to the tips of the inward protrusions 556a to 559a (especially where the plate is bent), the thickness is at least a little larger than that of the main region of the terminal body 511a. For example, the thickness may be 1.01 times or more, 1.5 times or more, 2 times or more, 5 times or more, 10 times or more, or 20 times or more of the thickness of the main region of the terminal body 511a. Moreover, the portion where the plate is bent may be formed by not squeezing the wire 301 and leaving the original sectional shape of the wire 301 as the inward protrusions.

Methods of thickening the plate thickness from the terminal body 511a to the tips of the inward protrusions 556a to 559a (especially where the plate is bent) (FIG. 5A and FIGS. 6A to 6C) include reduction of the squeezing amount of the wire. In this case, the thickness of the inward protrusions 556a to 559a increases, and the width thereof decreases. The inward protrusions 556a to 559a may have such a form.

Although the form in which the front and the back (the outer surfaces and the surfaces other than the outer surfaces) of the electrode terminals have different surface roughness is mainly explained in the above-mentioned embodiments, the front and the back (the outer surfaces and the surfaces other than the outer surfaces) of the electrode terminals may have the same surface roughness.

For example, although the element body 101 of the above-mentioned embodiments contains the resin material that does not include a magnetic material, the element body may be composed of a magnetic powder-containing resin that includes a magnetic powder.

The magnetic powder may be any magnetic powder and may include metal magnetic particles. Examples thereof include pure Fe, an Fe—Ni based alloy, an Fe—Si based alloy, an Fe—Co based alloy, an Fe—Si—Cr based alloy, an Fe—Si—Al based alloy, amorphous metal, a nano-crystalline alloy containing Fe, other soft magnetic alloys, and combinations thereof.

The magnetic particles may include ferrite particles. Examples of ferrite materials include a Ni—Zn based ferrite and a Mn—Zn based ferrite.

A subcomponent may be added to the magnetic powder as appropriate.

The metal magnetic particles included in the element body 101 may be insulated from each other. Examples of insulating methods include a method of forming an insulating film on a particle surface. Examples of the insulating film include a film formed from a resin or an inorganic material, and an oxidized film formed by oxidizing the particle surface in a heat treatment. When the insulating film is formed from a resin or an inorganic material, examples of the resin include a silicone resin and an epoxy resin.

Examples of the inorganic material include phosphates (e.g., magnesium phosphate, calcium phosphate, zinc phosphate, and manganese phosphate), silicates (e.g., sodium silicate (water glass)), soda lime glass, borosilicate glass, lead glass, aluminosilicate glass, borate glass, and sulfate glass. The thickness of the insulating film of the magnetic particles may be 5 nm to 200 nm. Formation of the insulating film can improve insulation properties among the particles and can improve, for example, the withstand voltage of the coil component.

The electronic component is not limited to a coil component (e.g., inductor) including the element body in which the coil portion is embedded. The electronic component may be, for example, a coil component in which a wire is wound around a dust core, a reactor, a transformer, or a contactless power supply device.

### REFERENCE NUMERALS

11 to 16 . . . coil component (electronic component)
101 . . . element body
101a . . . upper surface
101b . . . main surface (bottom surface)
101c to 101f . . . side surface
201 to 205 . . . air core coil (coil portion, electric element)
301 . . . wire (round wire)
311a, 311b . . . wire end
321a, 321b . . . squeezed portion
331a, 331b . . . excessive portion
341a, 341b . . . outward bent portion
356a, 356b . . . inward bent portion
365 . . . rectangular wire (wire)
375a, 375b . . . squeezed portion
501a to 510a, 501b to 507b . . . electrode terminal
511a to 519a, 511b to 515b . . . terminal body
521a, 521b . . . outer surface (first main surface)
531a, 531b . . . inner surface (second main surface)
541a to 549a, 541b to 545b . . . outward protrusion
556a to 558a, 556b to 557b . . . inward protrusion
561a, 561b . . . plating film
581a to 587a, 581b to 585b . . . lead-out portion
591a . . . lead-out formation location

What is claimed is:

1. An electronic component comprising:
an element body; and
an electrode terminal;
wherein the electrode terminal comprises a terminal body extending in a planar shape along a main surface of the element body, and an outward protrusion continuously and integrally formed with the terminal body and protruding outside the main surface.

2. An electronic component comprising:
an element body; and
an electrode terminal;
wherein the electrode terminal comprises a terminal body extending in a planar shape along a main surface of the element body, and an inward protrusion continuously and integrally formed with the terminal body and extending from the main surface into an inside of the element body.

3. The electronic component according to claim 2, wherein the electrode terminal further comprises an outward protrusion continuously and integrally formed with the terminal body and protruding outside the main surface.

4. The electronic component according to claim 1, wherein
the terminal body is continuously and integrally formed with a wire of an electric element embedded inside the element body;
the terminal body has a thickness smaller than that of the wire; and
the terminal body has a width larger than that of the wire.

5. The electronic component according to claim 2, wherein
the terminal body is continuously and integrally formed with a wire of an electric element embedded inside the element body;
the terminal body has a thickness smaller than that of the wire; and
the terminal body has a width larger than that of the wire.

6. The electronic component according to claim 3, wherein
the terminal body is continuously and integrally formed with a wire of an electric element embedded inside the element body;
the terminal body has a thickness smaller than that of the wire; and
the terminal body has a width larger than that of the wire.

7. The electronic component according to claim 4, wherein the terminal body extends in the planar shape along the main surface at least in a direction towards a center of the electric element.

8. The electronic component according to claim 5, wherein the terminal body extends in the planar shape along the main surface at least in a direction towards a center of the electric element.

9. The electronic component according to claim 4, wherein the electric element comprises a coil portion made of the wire.

10. The electronic component according to claim 5, wherein the electric element comprises a coil portion made of the wire.

11. The electronic component according to claim 4, wherein the element body comprises a resin.

12. The electronic component according to claim 11, wherein the element body comprises a magnetic powder.

13. The electronic component according to claim 1, wherein a protrusion length of the outward protrusion with respect to the terminal body is ½ or more of a thickness of the terminal body.

14. The electronic component according to claim 2, wherein a protrusion length of the inward protrusion with respect to the terminal body is ½ or more of a thickness of the terminal body.

15. The electronic component according to claim 1, wherein the outward protrusion has a thickness thicker towards a tip of the outward protrusion.

16. The electronic component according to claim 2, wherein the inward protrusion has a thickness thicker towards a tip of the inward protrusion.

17. The electronic component according to claim 1, wherein at least one of an inner surface or a side surface of the terminal body in contact with the element body has surface roughness larger than that of an outer surface of the terminal body opposite the inner surface.

18. The electronic component according to claim 2, wherein at least one of an inner surface or a side surface of the terminal body in contact with the element body has surface roughness larger than that of an outer surface of the terminal body opposite the inner surface.

19. The electronic component according to claim 1, wherein a plating film is formed at an outer surface of the terminal body opposite an inner surface thereof in contact with the element body.

20. A method of manufacturing an electronic component, comprising:
processing an end of a wire of an electric element into a sheet shape so that the end has a thickness smaller than that of the wire apart from the end and a width larger than that of the wire apart from the end;
forming an electrode terminal at the end processed into the sheet shape, the electrode terminal including a terminal body and at least one of an outward protrusion or an inward protrusion; and
forming an element body so that an outer surface of the electrode terminal is exposed and the electric element is covered by the element body.
